(19) United States
(12) Patent Application Publication
(10) Pub. No.: US 2015/0151533 A1
(43) Pub. Date: Jun. 4, 2015

(54) SLITTING KNIFE TRACKING

(71) Applicant: manroland web systems GmbH, Augsburg (DE)

(72) Inventors: Johann ERDT, Augsburg (DE); Siegmund Echerer, Neukirchen (DE)

(73) Assignee: manroland web systems GmbH, Augsburg (DE)

(21) Appl. No.: 14/559,650

(22) Filed: Dec. 3, 2014

(30) Foreign Application Priority Data
Dec. 4, 2013 (DE) 10 2013 113 421.1

(51) Int. Cl. B41F 13/58; B26D 5/02; B26D 5/00

(52) U.S. Cl. CPC B41F 13/58; B26D 5/007; B26D 5/02

(57) ABSTRACT

A method and a device for slitting a substrate web in a printing press by a slitting device are disclosed. The method and device includes a number of cutting knives, which are displaceably arranged transversely to the web running direction, and are able to react as quickly and exactly as possible to changes of the substrate web. To this end, printing parameters of the substrate web are measured and at least one of the cutting knives is transferred into a target position, where the target position is determined based on the measured printing parameters.

This application claims the priority of German Patent Document No. DE 10 2013 113 421.1, filed Dec. 4, 2013, the disclosure of which is expressly incorporated by reference herein.

### BACKGROUND AND SUMMARY OF THE INVENTION

The invention relates to a slitting knife device for slitting a substrate web in a printing press, comprising a number of cutting knives, which are displaceably arranged transversely to the web running direction and to a method for the slitting of such a substrate web.

For reducing production times, multiple print images are usually printed onto a substrate web of an appropriate width next to one another in a printing press. The substrate web is subsequently cut into multiple part webs by a slitting device in order to be able to finish the end product in further processing steps. The cutting knives of the slitting device in this case are positioned transversely to the web corresponding to the width of the part webs and the width of the substrate web.

A fixed arrangement of the cutting knives however results in that the slitting device no longer divides along the desired cutting lines of the substrate web not only upon a change of the print product, but also upon a change of the substrate web within the printing press, for example, shrinking, stretching or shifting during the course of the upstream processing steps. This regularly results in waste or print products of lower quality.

In this regard, a slitting device is known for example from EP 1415944 A1, in which a number of cutting knives are axially adjustable simultaneously and directly behind one another in order to reduce setting times and thus the amount of waste. However, operator-dependent intervention, i.e., a manually triggered reaction to changes of the substrate web in a manner of speaking, is additionally required with this embodiment.

The invention is therefore based on the object of stating a method for slitting a substrate web in a printing press and a slitting device, which can react as quickly and exactly as possible to changes of the substrate web.

With respect to the slitting device, this object is solved according to the invention with a knife system which meshes printing parameters of the substrate web and a control unit for transferring the cutting knives into a target position, wherein the control unit comprises an evaluation unit which is designed for determining the target position based on the measured printing parameters. With respect to the method, this object is solved according to the invention in that printing parameters of the substrate web are measured and at least one of the cutting knives is transferred into a target position, wherein the target position is determined based on the measured printing parameters.

Here, the invention is based on the consideration that exact slitting of a substrate web can be carried out with changed printing parameters of the substrate web, for example, the width of the substrate web, in particular when the cutting knives of the slitting device track the same. When determining the new position of the cutting knives, the target position, the changed characteristics of the substrate web should be taken into account in the process. These new characteristics in this case are determined with the help of a measurement system in the form of a determination of the printing parameters. The target value, i.e., the new positioning of the cutting knives, is then determined based on the determined printing parameters.

Printing parameters in this case can in particular be the position of position marks on the substrate web, but also the total width of the substrate web, provided this is detected by sensors. Alternatively, the printing parameter can also be derived via a change of the color register of the individual process colors.

In order to be able to determine the change of the substrate web, the measured printing parameters, the actual values, are compared with set point values in a preferred embodiment. These set point values in this case can be stored, manually entered in a separate database or a storage unit or measured by the measurement system proper. Here, a different value is determined from the actual value and the set point value which describes the change of the substrate web for the measured printing parameter, for example, the shrinking of the substrate web during the measurement of the width of the substrate web or individual known position marks. The target position of the cutting knife is then determined based on this differential value.

In a particularly preferred embodiment, a new target value for positioning a cutting knife is determined in particular only when the differential value exceeds a limit value stored in a database or in a storage unit or determined based on the actual and/or set point values. Thus, production tolerances can be set within which a change of the substrate web does not trigger any readjustment of the cutting knives.

To determine the printing parameters, the measurement system in an advantageous embodiment comprises a number of sensors. Here, in a particularly preferred configuration, at least one sensor can be moved over the substrate web. Such a sensor can be specifically positioned in the region of the substrate web to be measured or determine printing parameters, which depend on the position or extension of the substrate web or individual parts or regions thereof. Alternatively, a number of sensors can be employed either over the entire web width or over regions of the web, in particular at least an edge region of the web in order to directly detect, for example, the web width of the substrate web in this way.

In order to be able to determine the change of the characteristics of the substrate web as accurately as possible, at least two sensors are provided in a particularly advantageous configuration, wherein a first sensor is arranged in a web running direction in front of a second sensor. Here, the first sensor determines the starting parameters of the substrate web, which can also be used as set point values for the calculation of the target position later on, and the second sensor the current parameters of the substrate web once it has passed through the printing press or through a part region of the same. To this end, the first sensors are advantageously arranged in front of the printing units and the second sensors in the web running direction in front of the cutting knives.

To determine the position of position marks on the substrate web or printing parameters that can be optically detected generally, at least one sensor in an advantageous embodiment comprises a camera. Because of this, changes of the substrate web in particular can be detected which relate to the position and extension of the substrate web, such as, for example, shrinking or widening, for example, through the so-called fan-out effect. Alternatively, the actual value or the nominal value of the web width in front of the printing units can also be used from the paper data assigned to the respective paper reel.

The advantages achieved with the invention consist in particular in that through the measurement of the printing parameters of the substrate, web changes in the same can be directly determined and the cutting knives thus accurately positioned and readjusted. Thus, exact slitting, and thus, a high-quality end product are possible even in the case of shrinkage or widening or another change of the substrate web.

An exemplary embodiment of the invention is explained in more detail with the help of a drawing.

### BRIEF DESCRIPTION OF THE DRAWING

FIG. 1 shows a slitting device for slitting a substrate web according to the principles of the present invention.

### DETAILED DESCRIPTION OF THE DRAWING

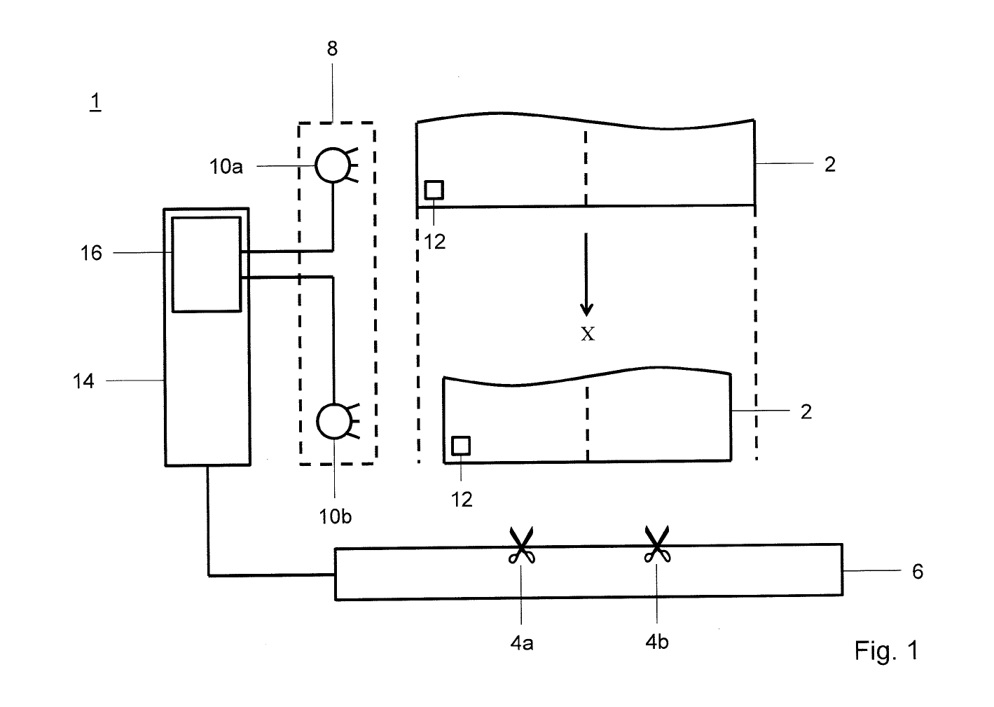

FIG. 1 therein shows a slitting device 1 for slitting a substrate web 2. The slitting device 1 in this case exemplarily comprises two cutting knives 4a, 4b which can be displaced along a rail 6, transversely to the web running direction x over the entire width of the substrate web 2, in order to be able to cut the substrate web 2 into three, or with deactivated first or second cutting knife 4a, 4b, two part webs of desired widths.

In order that the desired widths or width conditions of the part webs can also be maintained after a change of the substrate web 2, for example, through shrinking or widening of the substrate web 2 following the passing through the printing units or other part regions of the printing press, the slitting device 1 comprises a measurement system 8, which comprises two sensors 10a, 10b. The first sensor 10a in this case is arranged in a region in which the substrate web 2 is still substantially unchanged, i.e., usually in a region at the start of the production run, as, for example, in the region of the reel changer or in front of the printing units. This first sensor 10a is designed as a camera and in the exemplary embodiment according to FIG. 1 determines the position of position marks 12 on the substrate web 2.

The original position of the position mark 12 so determined is used as a set point value in the calculation of the target position of the cutting knives later on. In an alternative or additional configuration, it is also conceivable that set point values can be stored or entered in a database which is not shown or a storage unit which is not shown. The second sensor 10b is arranged in the immediate vicinity of the cutting knives 4a, 4b or after the units of the printing press triggering the change of the substrate web 2. The second sensor 10b is designed as a camera and determines the position of the position mark 12. The position so determined is used as an actual value in calculating the target position.

For positioning the cutting knives 4a, 4b or for readjusting the cutting knives 4a, 4b based on changes of the substrate web, the slitting device 1 comprises a control unit 14, which comprises an evaluation unit 16. In this evaluation unit 16, the actual value determined out of the second sensor 10b is compared with a set point value provided by the database, by the storage unit, by an input unit or by the first sensor 10a. Here, a differential value is determined between the set point value and the actual value which describes the change of the substrate web, in this case the shrinkage. Based on this differential value, the target position of both cutting knives 4a, 4b is determined. In the case of the shown shrinkage of the substrate web 2, the cutting knives are therefore repositioned corresponding to the shrinkage factor. The evaluation unit 16 in this case is additionally designed in order to additionally monitor a limit value. This means that a new target position, and thus, its tracking by the cutting knives 4a, 4b is only determined in particular when the differential value of the set point value and of the actual value exceeds a stored or determined limit value. Thus, production tolerances can be stored or be dynamically determined based on the measured printing parameters and/or based on the current position of the cutting knives 4a, 4b within which tracking by the cutting knives 4a, 4b is not performed.

Even though the exemplary embodiment is designed exemplarily for determining position marks 12 and the shrinkage of the substrate web 2, the measurement system 8 can in an alternative or additional configuration be designed in order to determine general printing parameters and changes of the substrate web 2 which require these being tracked by the cutting knives 4a, 4b.

### LIST OF REFERENCE NUMBERS

1 Slitting device
2 Substrate web
4a First cutting knife
4b Second cutting knife
6 Rail
8 Measurement system
10a First sensor
10b Second sensor
12 Position mark
14 Control unit
16 Evaluating unit
x Web running direction

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for slitting a substrate web in a printing press by a slitting device that includes a plurality of cutting knives which are displaceably arranged transversely to a web running direction, comprising the steps of:
measuring a printing parameter of the substrate web;
determining a target position based on the measured printing parameter; and
transferring at least one of the plurality of cutting knives into the target position.

2. The method according to claim 1, wherein a differential value is determined from the measured printing parameter and a stored, measured, or entered set point value wherein the target position is determined as a function of the differential value.

3. The method according to claim 2, wherein the differential value represents a dimension for a shrinkage of a width of the substrate web.

4. The method according to claim 2, wherein the target position is determined when the differential value exceeds a stored or a determined limit value.

5. The method according to claim 1, wherein the printing parameter is a position of a position mark on the substrate web.

6. A slitting device for slitting a substrate web in a printing press, comprising:
a plurality of cutting knives, wherein the plurality of cutting knives are displaceably arranged transversely to a web running direction;
a measurement system, wherein the measurement system measures a printing parameter of the substrate web; and
a control unit, wherein the plurality of cutting knives are transferable into a target position by the control unit and wherein the control unit includes an evaluation unit which determines the target position based on the measured printing parameter.

7. The slitting device according to claim 6, wherein the measurement system includes a plurality of sensors.

8. The slitting device according to claim 7, wherein at least one of the plurality of sensors detects the substrate web over an entire width of the substrate web.

9. The slitting device according to claim 7, wherein at least one of the plurality of sensors is moveable over a width of the substrate web.

10. The slitting device according to claim 7, wherein the measurement system includes a first sensor and a second sensor and wherein the first sensor is arranged in a web running direction in front of the second sensor.

11. The slitting device according to claim 10, wherein the first sensor is arranged in front of a printing unit and the second sensor is arranged in front of the plurality of cutting knives.

12. The slitting device according to claim 7, wherein at least one of the plurality of sensors is a camera.
